(19) United States
(12) Patent Application Publication
(10) Pub. No.: US 2019/0162024 A1
(43) Pub. Date: May 30, 2019

(54) ROLLER BLIND END BRACKET WITH FASCIA SUPPORT

(71) Applicant: ZMC Metal Coating Inc., Woodbridge (CA)

(72) Inventor: Philip NG, Thornhill (CA)

(73) Assignee: ZMC Metal Coating Inc., Woodbridge (CA)

(21) Appl. No.: 16/179,229

(22) Filed: Nov. 2, 2018

Related U.S. Application Data
(60) Provisional application No. 62/592,458, filed on Nov. 30, 2017.

(51) Int. Cl. E06B 9/42; E06B 9/58

(52) U.S. Cl. CPC E06B 9/42; E06B 2009/587; E06B 2009/583; E06B 9/58

(57) ABSTRACT

An end bracket for a roller blind for use with a fascia is provided. The end bracket includes a plate adapted for mounting to a surface. The plate has a side flange and a roller tube mounting portion for supporting an end of a roller tube of the roller blind. The end bracket also includes a support segment pivotally coupled to the side flange of the plate. The support segment is pivotable between a first position, in which the support segment extends generally parallel to the roller tube mounting portion, and a second position, in which the support segment extends outwardly from, and generally perpendicular to, the roller tube mounting portion. When in the first position, the support segment is releasably securable to a fascia panel. When in the second position, the support segment permits unobstructed access to the roller tube mounting portion.

### CROSS REFERENCE TO RELATED APPLICATIONS

This non-provisional application claims priority to U.S. Provisional Patent Application Ser. No. 62/592,458, filed on Nov. 30, 2017.

### TECHNICAL FIELD

This invention relates generally to roller blinds, window shades, other similar types of window coverings, and in particular to an end bracket plate for such devices.

### BACKGROUND

In many instances, roller blinds and window shades are either mounted externally to a window or internally within the limits of the window's frame. In such cases, a fascia with a front plate extending perpendicularly from a bottom plate may be utilized in order to partially enclose the roller blind or window shade and obscure it from view from the bottom and the front.

Conventionally, in order to support the fascia, the end bracket of a roller blind typically has a tongue fixed to, and extending perpendicularly away from, its bottom edge. The tongue extends outwardly from the centre of the bottom edge of the end bracket and engages a flange, notch or lip on the bottom plate of the fascia to provide support for the fascia. However, fixed and positioned in such a manner, the tongue may also obstruct vertical movement of the roller blind, such as during installation and/or removal of the roller blind.

### SUMMARY

In one aspect the invention there is provided an end bracket for a roller blind for use with a fascia. The end bracket includes a plate adapted for mounting to a surface. The plate has a side flange and a roller tube mounting portion for supporting an end of a roller tube of the roller blind. The end bracket also includes a support segment pivotally coupled to the side flange of the plate. The support segment is pivotable between a first position, in which the support segment extends generally parallel to the roller tube mounting portion, and a second position, in which the support segment extends outwardly from, and generally perpendicular to, the roller tube mounting portion. When in the first position, the support segment is releasably securable to a fascia panel. When in the second position, the support segment permits unobstructed access to the roller tube mounting portion.

### BRIEF DESCRIPTION OF THE DRAWINGS

For a better understanding of the present invention, and to show more clearly how it may be carried into effect, reference will now be made, by way of example, to the accompanying drawings which show exemplary embodiments of the present invention in which:

FIG. 1 is an upper rear perspective view of a prior art end bracket with a conventional fascia;

FIG. 2 is an upper front perspective view of the prior art end bracket of FIG. 1 as a roller blind is being installed;

FIG. 3 is an enlarged and exploded upper front perspective view of an end bracket according to example embodiment of the present invention;

FIG. 4 is an upper rear perspective view of the end bracket of FIG. 3;

FIG. 5 is a side elevational view of the end bracket of FIG. 3 assembled in a first position;

FIG. 6 is a plan view of the end bracket of FIG. 5;

FIG. 7 is a side elevational view of the end bracket of FIG. 5 in a second position;

FIG. 8 is a plan view of the end bracket of FIG. 7;

FIG. 9 is an upper perspective view of the end bracket of FIG. 5 in use with a fascia without the roller blind installed;

FIG. 10 is an upper front perspective view of the end bracket of FIG. 7 in the second position when a roller blind is being installed;

FIG. 11 is a view subsequent to FIG. 10 where in the roller blind has been installed;

FIG. 12 is an upper front perspective view of the end bracket and roller blind of FIG. 11 with the fascia installed;

FIG. 13 is an exploded view of FIG. 12.

### DETAILED DESCRIPTION

The present invention may be embodied in a number of different forms. The specification and drawings that follow describe and disclose some of the specific forms of the invention.

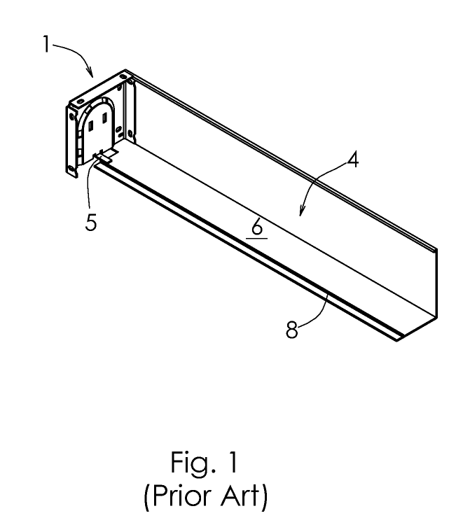

FIG. 1 shows a traditional end bracket 1 for a roller blind tube (not shown). In order to support a fascia 4, end bracket 1 typically has a tongue 5 fixed to, and extending perpendicularly from, its bottom edge generally parallel to the longitudinal axis of the roller tube. A bottom plate 6 of fascia 4 is typically spaced apart from the bottom edge of end bracket 1, particularly when end bracket 1 is a clutch bracket. This provides a gap through which a cord or chain 7 (not shown) of the clutch can travel. Tongue 5 thus extends from the bottom edge of end bracket 1, bridging the gap to engage a lip 8 on bottom plate 6 of fascia 4, thus providing support for fascia 4 without obstructing the movement of the chain or cord.

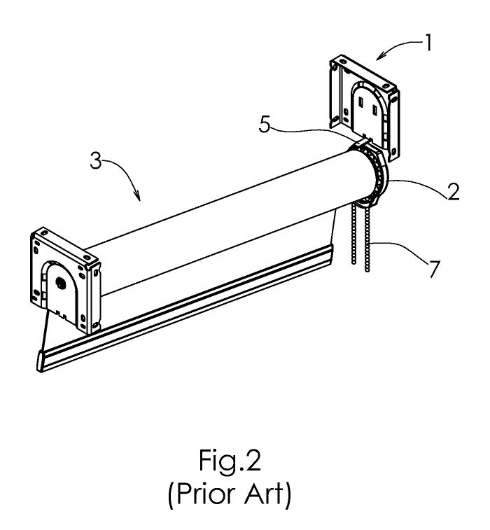

However, as shown in FIG. 2, tongue 5 may obstruct vertical movement of roller tube 3 during installation. That is, typically the idle end of roller tube 3 is first secured to one of the end brackets. Clutch end 2 of roller tube 3 will then need to travel past the bottom edge of end bracket 1 in order to access the mounting portion of end bracket 1, all the while not allowing the idle end to be released from the opposite end bracket. The location and rigidity of tongue 5 may make it difficult for the clutch end of roller tube 3 to be brought into contact with the mounting portion of end bracket 1 in order to secure the clutch end to the bracket. Similar difficulties may be encountered during removal of roller tube 3, and/or when securing the idle end of the roller tube to its end bracket.

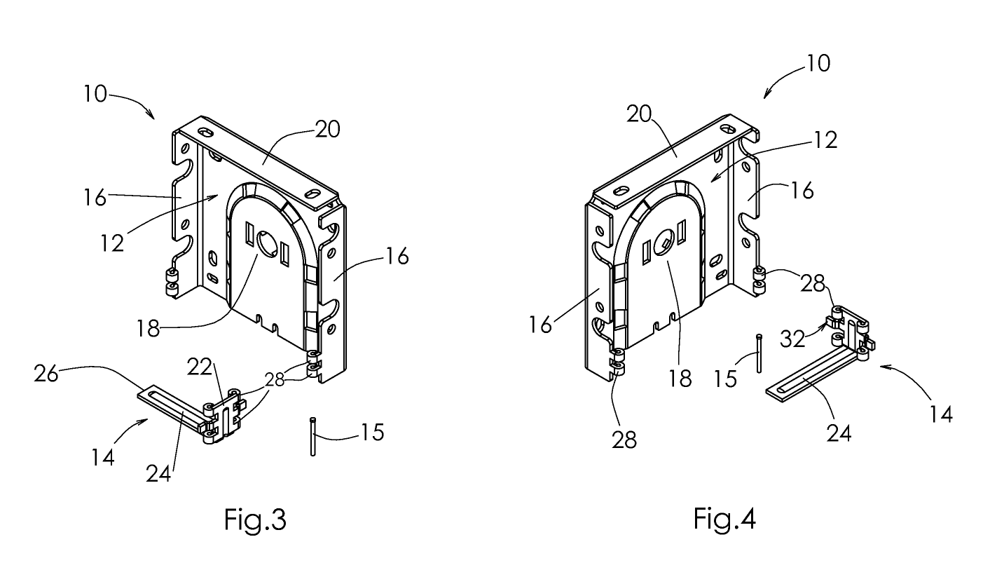

Turning now to FIGS. 3-8, there is shown an end bracket 10 according to an example embodiment of the present invention.

FIGS. 3 and 4 show exploded views of end bracket 10 for use with roller tube 3. Here end bracket 10 includes a plate 12, adapted for mounting to a surface, a support segment 14, and a pin 15. Plate 12 is shown as including two side flanges 16 and a roller tube mounting portion 18 for supporting an end of a roller tube. End bracket 10 may further include a top flange 20.

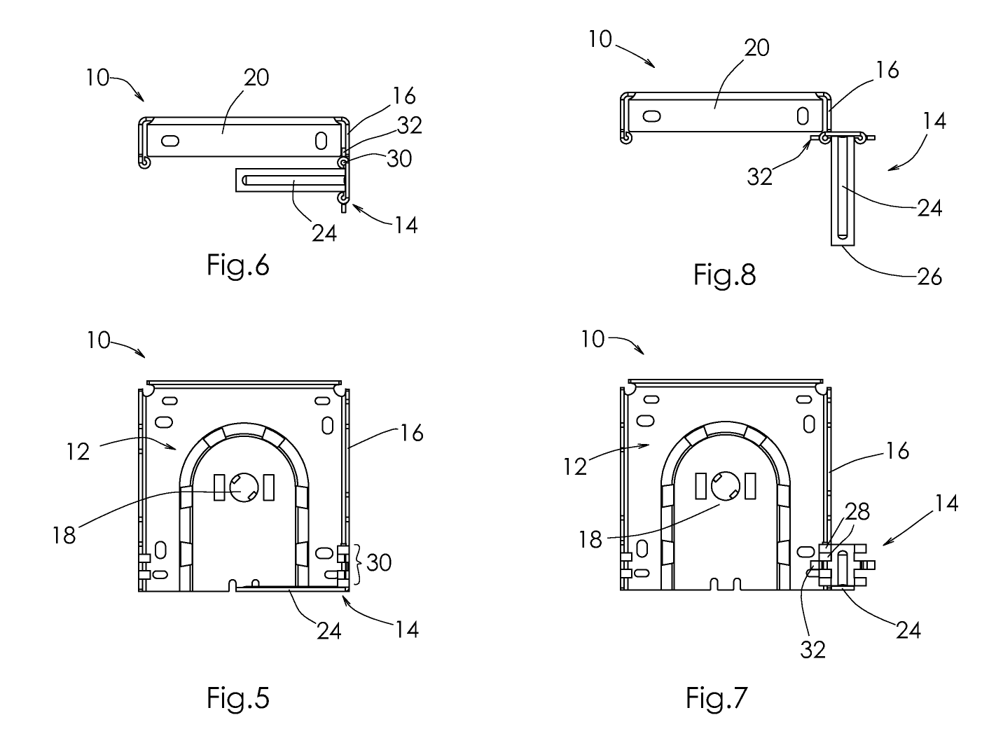

Support segment 14 includes a connector 22, which is configured to be coupled to one of side flanges 16, and a tongue 24 which extends generally perpendicularly from connector 22 to an end 26. Tongue 24 is configured for engagement with the bottom of fascia 4 (not shown in FIGS. 3 and 4). In the depicted embodiment, support segment 14 and side flange 16 each have knuckles 28. As best seen in FIGS. 5-8, knuckles 28 of support segment 14 and side flange 16, collectively, along with pin 15, form a hinge 30. When assembled, support segment 14 is pivotally coupled via hinge 30 to one of side flanges 16 of plate 12. Support segment 14 will thus have a first position (see FIGS. 5 and 6), in which support segment 14 extends generally parallel to roller tube mounting portion 18 (perpendicular to the roller tube), and a second position (see FIGS. 7 and 8), in which support segment 14 extends outwardly from, and generally perpendicular to, roller tube mounting portion 18 (parallel to the roller tube).

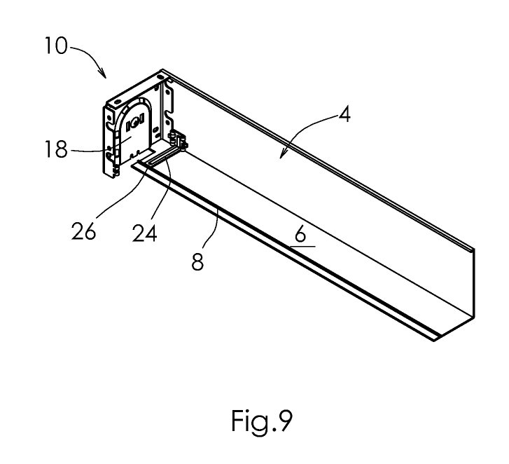

In this manner, when support segment 14 is in its first position, it can help to releasably secure fascia panel or bottom 6 to plate 12 (see FIG. 9 for example). In the embodiment of FIG. 9, end 26 of tongue 24 is configured to snap-fit with lip 8 on bottom 6 of fascia 4. In alternate embodiments the fascia may be secured along its upper front ends to one of the side flanges of the end brackets, with lip 8 compressed against tongue 24 holding the fascia in place. Regardless, it will be appreciated that tongue 24 helps to releasably secure fascia 4 to end bracket 10. As shown, support segment 14 is also preferably spaced apart from roller tube mounting portion 18 when support segment 14 is in its first position. This allows chain or cord 7 of the roller blind (not shown) to freely travel there between.

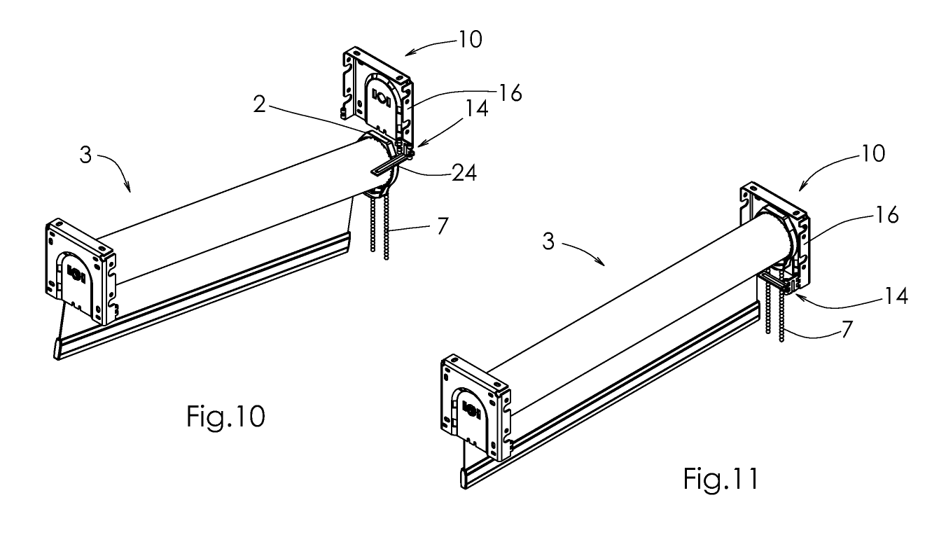

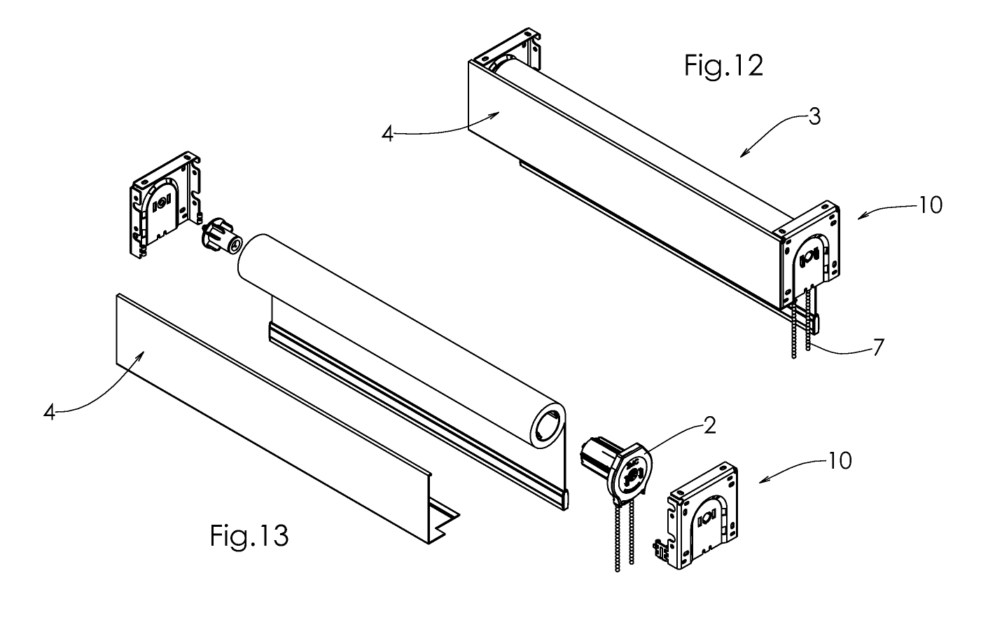

When support segment 14 is in its second position, and tongue 24 extends away from roller tube mounting portion 18, support segment 14 permits unobstructed access to roller tube mounting portion 18, for installation or removal of the roller tube, as best seen in FIG. 10. After the end of the roller tube is secured to end bracket 10, support segment 14 can be rotated or pivoted to its first position, as shown in FIG. 11. Fascia 4 may then be installed as depicted in FIGS. 12 and 13.

There are a number of ways in which end bracket 10 may be configured in order to help support segment 14 remain in its first or second position.

In an embodiment, one of support segment 14 and side flange 16 includes a stop 32 for limiting pivotal movement of support segment 14 beyond its first position. In the particular embodiment shown in FIGS. 3-8, stop 32 is a tab extending from connector 22, between knuckles 28 and which bears against side flange 16 of plate 12 when support segment 14 is in its first position (see FIG. 6). In this manner, tab 32 prevents support segment 14 from being rotated past a position where it is perpendicular from the roller tube, such that end 26 will be aligned for engagement with lip 8 when fascia 4 is attached to end brackets 10.

That is, the tab effectively acts as a rotational stop.

As will be understood by the skilled worker, stop 32 could be part of side flange 16 rather than support segment 14. Alternatively, both side flange 16 and support segment 14 may include a stop or inter-engageable components of a stop.

Knuckles 28 and pin 15 may also be close fitted such that friction between knuckles 28 on support segment 14 and side flange 16 makes movement between support segment 14 and side flange 16 relatively difficult. In this case, the friction between support segment 14 and side flange 16 helps to maintain support segment 14 in its first or second position.

Further, stop 32, connector 22 and/or side flange 16 may include one or more fasteners to releasably maintain support segment 14 in its first and/or second position. Such fasteners could include interlocking components on both support segment 14 and side flange 16 which releasably snap together or otherwise co-operate when support segment 14 is in the first position. A magnet could also be used to help maintain support segment 14 in its first or second position.

The described structure thus not only permits cord or chain 7 to travel unhindered when roller tube 3 is installed, but the pivotability of support segment 14 allows support segment 14 to rotate away from roller tube mounting portion 18 to its second position, and to provide unhindered access of the roller tube to plate 12. The pivotability of support segment 14 permits it to also provide support for fascia 4 when rotated to its first position.

It is to be understood that what has been described are the preferred embodiments of the invention. The scope of the claims should not be limited by the preferred embodiments set forth above, but should be given the broadest interpretation consistent with the description as a whole.

I claim:

1. An end bracket for a roller blind, the end bracket comprising:
a plate adapted for mounting to a surface, said plate having a side flange and a roller tube mounting portion for supporting an end of a roller tube of the roller blind; and
a support segment pivotally coupled to said side flange of said plate, said support segment pivotable between a first position, in which said support segment extends generally parallel to said roller tube mounting portion, and a second position, in which said support segment extends outwardly from, and generally perpendicular to, said roller tube mounting portion,
when in said first position, said support segment releasably securable to a fascia panel, when in said second position, said support segment permitting unobstructed access to said roller tube mounting portion.

2. The end bracket of claim 1, wherein said support segment is spaced apart from said roller tube mounting portion when said support segment is in said first position, allowing a chain or cord of the roller blind to freely travel there between.

3. The end bracket of claim 2, wherein said support segment comprises a connector coupled to said side flange, and a tongue extending generally perpendicularly from said connector, said tongue for engaging the fascia panel.

4. The end bracket of claim 3, wherein said support segment is pivotally secured to said side flange through a hinge joint.

5. The end bracket of claim 4, wherein said support segment terminates at an end, the end configured to engage a lip on the fascia panel.

6. The end bracket of claim 5, wherein one of said support segment and said side flange includes a stop for limiting pivotal movement of said support segment.

7. The end bracket of claim 6, wherein said stop extends from said connector and bears against said plate when said support segment is in said first position.

8. The end bracket of claim 5, wherein said hinge joint is frictionally tight to help maintain said support segment in said first or said second position.

9. The end bracket of claim 6, including a fastener to releasably maintain said support segment in said first position.

10. The end bracket of claim 6, wherein said fastener comprises a magnet.
